(19) United States
(12) Patent Application Publication
(10) Pub. No.: US 2005/0062360 A1
(43) Pub. Date: Mar. 24, 2005

(54) Thermal engine and thermal power generator both using magnetic body

(75) Inventor: Hisato Yabuta, Hiroshima (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/934,512

(22) Filed: Sep. 7, 2004

(30) Foreign Application Priority Data
Sep. 8, 2003 (JP) 2003-316087(PAT.)
Sep. 8, 2003 (JP) 2003-316088(PAT.)

(51) Int. Cl. H02N 10/00

(52) U.S. Cl. 310/306

(57) ABSTRACT

It is possible to gain a large magnetization difference, and hence obtain a large mechanical or electric energy output, even with a small difference between the heating and cooling temperature for a magnetic body whose magnetization varies with temperature. There is provided a thermal engine or power generator using a magnetic body which converts heat to a mechanical or an electric energy by cycling heating and cooling the magnetic body, wherein energy is obtained by cycling heating and cooling a temperature-sensitive magnetic material.

### BACKGROUND OF THE INVENTION

1. Field of the Invention

The present invention relates to a thermal engine and thermal power generator both using a magnetic body, and specifically to a thermal engine or thermal power generator, both using a magnetic body, which recycles low quality heat such as heated wastewater discharged from a factory or the like, and converts it into mechanical or electric power.

2. Related Background Art

A thermal power generator using a magnetic body utilizes a magnetic material having a magnetization variable with temperature, and several kinds of such devices have been proposed to date. For the magnetic material with a magnetization variable with temperature, the so-called magnetic shunt materials or alloys such as Permalloy, a ferronickel alloy, are widely utilized.

FIG. 1 illustrates an example of a thermal power generator using the magnetic body. In the device illustrated by FIG. 1, the permanent magnets 2 are disposed to sandwich a magnetic body 1 made of a magnetic material with a magnetization variable with temperature, and a yoke 3 is set up to connect the two permanent magnets and thereby a magnetic circuit is formed in which a coil 4 is wound to generate voltages corresponding to changes in the magnetic flux of the yoke 3 (refer to Japanese Patent Application Laid-Open No. 2002-266699). Ferrite is shown as an example of the magnetic body 1.

In the device illustrated by FIG. 1, the magnetic body 1 is made of a material whose permeability and hence the magnetization increases as it is cooled. As the permeability increases, the magnetic circuit becomes closed and hence the magnetic flux through the yoke 3 increases. By this, the coil 4 generates the electromotive force corresponding to a change in the magnetic flux therein, hereby electric power can be generated. Heating the magnetic body 1 decreases the permeability and the magnetic flux through the yoke 3 decreases, making the coil 4 generate the electromotive force in the sign opposite to that in the case of cooling the magnetic body 1. Therefore, the cycling of heating and cooling causes the coil 4 to generate AC power output.

In Japanese Patent Application Laid-Open No. H9-268968, a thermo-magnetic engine as illustrated in FIG. 2 is disclosed as a thermal engine in which a magnet 2 is mounted close to a cylindrical body 1 made of a magnetic material with a magnetization variable with temperature. A part of the cylindrical body 1, a little away in either directions circumferentially from its part adjacent to the magnet 2, is heated whereas the corresponding part in the circumferentially opposite direction is cooled simultaneously. This causes a thermal gradient between the heated and the cooled parts of the cylindrical body. In this device, the magnetic material used has a magnetization increasing as it is cooled, an example of which is Permalloy whose magnetization increases as its temperature decreases in the range up to 70° C. Therefore, the magnetization of the cylindrical body close to the magnet gradually increases from the heated part 5 toward the cooled part 6. In other words, there is a magnetization gradient. In this instance, the interaction between the magnetic field generated by the magnet 2 and the magnetization of the magnetic material generates a force to attract the cooled part toward the magnet, resulting in the cylindrical body 1 starting to rotate in a direction from the cooled part to the heated part. It is possible to make the cylindrical body 1 rotate permanently by heating and cooling the same positions, respectively, in relation to the magnet (that is, heating and cooling, on the rotating cylindrical body, the parts adjacent to the magnets in the rotating direction 7 and the opposite, respectively) so as to create a thermal gradient (and therefore, magnetization gradient) continuously in the magnetic material. In Japanese Patent Application Laid-Open No. H9-268968, another example by using ferrite as a magnetic material with a magnetization variable with temperature is disclosed.

FIG. 3 shows the magnetization variation as a function of temperature for Ni₇₀Fe₃₀ alloy as a typical example of a magnetic material with a magnetization variable with temperature.

FIG. 3 indicates that the magnetization decreases in an approximately constant gradient in relation to temperature rise between 30° C. and 110° C. A temperature difference of 20° C. causes a magnetization variation approximately of 0.1 tesla, and thus a temperature rise from 30° C. to 110° C. causes a magnetization variation of approximately 0.4 tesla.

Accordingly, in the device as illustrated by FIG. 2, assuming that the cylindrical body 1 made of Ni₇₀Fe₃₀ alloy is used and the magnetic field generated by the magnet 2 is 1 tesla, the magnetic energy difference ΔU per unit volume between the cooled and heated parts of the magnetic material is given by the following equation, ΔU=−ΔM ·H=0.1/μ₀ (μ₀: permeability of vacuum) where ΔM is the difference in magnetization between the cooled and heated parts, μ₀H is the magnetic field generated by the magnet, and the cooling temperature at 30° C. and the heating temperature at 50° C. This energy difference minus losses such as those with friction and eddy current is an available mechanical energy. As such, by the magnetization gradient as indicated by FIG. 3, if the temperature difference is as small as 20° C., the available magnetic energy difference ΔU is small, and therefore a temperature difference no less than 200° C. is required to gain a necessary difference in magnetization ΔM to obtain a practical amount of the mechanical energy.

On the other hand, thermal engines using the temperature-sensitive magnetic materials aim at recycling and utilizing a relatively low temperature heat, i.e., a low quality heat, such as heated wastewater from the factories, exhaust heat from equipment, and natural heat source such as geothermal heat. This requires a large magnetization difference ΔM even with a small difference between a heat source (such as heated wastewater from the factories) and a cooling source (primarily atmospheric air or water), thus obtaining a large mechanical or electric energy output.

However, the above described thermal engines or thermal power generators find it hard to gain a large magnetization difference if the temperature difference between a heat and a coolant sources is small.

The present invention provides a thermal engine or a thermal power generator generating large mechanical energy outputs by obtaining large magnetization differences even with small temperature differences.

### SUMMARY OF THE INVENTION

The present invention relates to a thermal engine using a magnetic body having a magnetization variable with temperature as a result of the phase transition from the normal to a stronger magnetization, and converting heat into a mechanical energy by cycling heating and cooling the magnetic body, comprising: a heat source to heat up the magnetic body; a cooling source to cool down the magnetic body; support means for supporting the magnetic body movably; magnetic field generation means for generating a field in a part of the moving area; and means for causing the magnetization variation in the magnetic body in a part of the moving area where a field is generated by the magnetic field generation means and in either side of the moving area by subjecting the magnetic body to the heating by the heat source and cooling by the coolant source, wherein the heating and cooling temperatures straddle a temperature at which the magnetic body indicates the maximum magnetization variation with temperature as a result of the primary phase transition thereof.

The present invention further relates to a thermal engine using a magnetic body having a magnetization variable with temperature as a result of the phase transition from the normal to a stronger magnetization, and converting heat into a mechanical energy by cycling heating and cooling the magnetic body, comprising: a heat source to heat up the magnetic body; a cooling source to cool down the magnetic body; support means for supporting the magnetic body movably; magnetic field generation means for generating a field in a part of the moving area; and means for causing the magnetization variation in the magnetic body in a part of the moving area where a field is generated by the magnetic field generation means and in either side of the moving area by subjecting the magnetic body to the heating by the heat source and cooling by the coolant source, wherein the heating and cooling temperatures straddle a temperature at which the magnetic body undergoes the secondary phase transition indicating the maximum magnetization variation with temperature as steep as in the primary phase transition thereof.

The present invention further relates to a thermal-engine using a magnetic body having a magnetization variable with temperature as a result of the phase transition from the normal to a stronger magnetization, and converting heat into a mechanical energy by cycling heating and cooling the magnetic body, comprising: a heat source to heat up the magnetic body; a cooling source to cool down the magnetic body; support means for supporting the magnetic body movably; magnetic field generation means for generating a field in a part of the moving area; and means for causing the magnetization variation in the magnetic body in a part of the moving area where a field is generated by the magnetic field generation means and in either side of the moving area by subjecting the magnetic body to the heating by the heat source and cooling by the coolant source, wherein the magnetic body indicates a magnetization variation of 0.5 tesla or greater for the difference between the heating and cooling temperatures being 10° C. or less.

The present invention relates to a thermal power generator using a magnetic body having a magnetization variable with temperature as a result of the phase transition from the normal to a stronger magnetization, and converting heat into an electric energy by cycling heating and cooling the magnetic body, comprising: a heat source to heat up the magnetic body; a cooling source to cool down the magnetic body; and operating means for subjecting the magnetic body alternately to the heating by the heat source and cooling by the coolant source, wherein the heating and cooling temperatures straddle a temperature at which the magnetic body indicates the maximum magnetization variation with temperature as a result of the primary phase transition thereof.

The present invention further relates to a thermal power generator using a magnetic body having a magnetization variable with temperature as a result of the phase transition from the normal to a stronger magnetization, and converting heat into an electric energy by cycling heating and cooling the magnetic body, comprising: a heat source to heat up the magnetic body; a cooling source to cool down the magnetic body; and operating means for subjecting the magnetic body alternately to the heating by the heat source and cooling by the coolant source, wherein the heating and cooling temperatures straddle a temperature at which the magnetic body undergoes the secondary phase transition indicating the maximum magnetization variation with temperature as steep as in the primary phase transition thereof.

The present invention further relates to a thermal power generator using a magnetic body having a magnetization variable with temperature as a result of the phase transition from the normal to a stronger magnetization, and converting heat into an electric energy by cycling heating and cooling the magnetic body which is magnetized beforehand, comprising: a heat source to heat up the magnetic body; and operating means for subjecting the magnetic body alternately to the heating by the heat source and cooling by the coolant source, wherein the magnetic body indicates a magnetization difference of 0.5 tesla or greater for the difference between the heated and the cooled temperatures being 10° C. or less.

### BRIEF DESCRIPTION OF THE DRAWINGS

FIG. 1 illustrates a thermal power generator using a conventional temperature-sensitive magnetic material;

FIG. 2 illustrates a thermal engine converting heat to a mechanical energy;

FIG. 3 indicates the magnetization characteristics of Ni₇₀Fe₃₀ alloy, a temperature-sensitive magnetic material, as a function of temperature;

FIG. 4A and FIG. 4B illustrate the magnetization excursions of the materials according to the present invention as a function of temperature, in which the primary phase transition causes the normal and a stronger magnetizations;

FIG. 5 illustrates the magnetization excursions of MnAs and Mn(As_{0.95}Sb_{0.05}) as a function of temperature according to the present invention;

FIG. 6 illustrates a thermal engine using a temperature-sensitive magnetic material according to the present invention; and

FIG. 7 illustrates a thermal power generator using a temperature-sensitive magnetic material according to the present invention.

### DESCRIPTION OF THE PREFERRED EMBODIMENTS

A thermal engine according to the present invention uses a temperature-sensitive magnetic material in which the primary phase transition in the temperature change causes the normal and a stronger magnetization, and the transition at around the phase transition temperature (Curie temperature) provides a steeper change in magnetization as compared to that of the conventional temperature-sensitive magnetic materials. It is possible to use alternatively a similar material in which the secondary phase transition in the temperature change causes the normal and a stronger magnetizations in substantially the same condition as the primary phase transition, and the transition at around the Curie temperature provides a steeper change in magnetization as compared to that of the conventional temperature-sensitive magnetic materials.

FIGS. 4A and 4B illustrate the magnetization excursion of the material according to the present invention as a function of temperature, in which the primary phase transition causes the normal and a stronger magnetizations.

As illustrated in FIG. 4A, for a material which steeply varies the magnetization at around the Curie temperature Q, a heating temperature of the temperature-sensitive magnetic material used in the thermal engine according to the present invention (hereinafter called heating temperature) H and a cooling temperature thereof (hereinafter called cooling temperature) C are set straddling the Curie temperature. That is, the heating temperature is set at slightly higher than the Curie temperature, while the cooling temperature at slightly lower than it, hence gaining a large difference in magnetization between the heated and cooled parts. As such, the magnetization difference produces a large mechanical energy.

As circled by a dotted line X in FIG. 4B, a hysteresis in magnetization at around the Curie temperature is normally observed with the primary phase transition. In this case, the heating temperature H is set at slightly higher than the highest temperature on the warm-up hysteresis curve, while the cooling temperature C at slightly lower than the lowest temperature on the cool-down hysteresis curve. In this way, a large difference in magnetization between the heated and cooled parts is gained. Accordingly, a small temperature difference produces a large mechanical energy.

Such materials which exhibit transition from the normal to a stronger magnetization with temperature change as the primary phase transition as described above include Mn(As,Sb), MnFe(P,As), La(Fe,Si)₁₃Hy and Gd₅(Si,Ge)₄. Although the phase transition of these materials, depending on the composition, can be the secondary, the magnetization differences are as steep in similar conditions as the primary phase transition. That is, even if a material is used in which the transition from the normal to a stronger magnetization with the temperature change is through the secondary phase transition, it is within the scope of the present invention so long as it indicates a large magnetization difference with a small temperature difference. Any combination of these materials is also acceptable. Such a combination makes it possible to establish a scope of temperature wherein a large magnetization can be obtained under even a small difference of temperature.

As described above, the present invention makes it possible to gain a large difference in magnetization even with a small difference between the heating and cooling temperatures by using a material in which the transition from the normal to a stronger magnetization with the temperature change is through the primary phase transition. It is preferable to obtain a magnetization difference of 0.5 tesla or greater for the temperature difference of 10° C. or less.

(Embodiment 1)

This embodiment is a thermal engine according to the present invention using MnAs and Mn(As_{0.95}Sb_{0.05}) as temperature-sensitive magnetic materials.

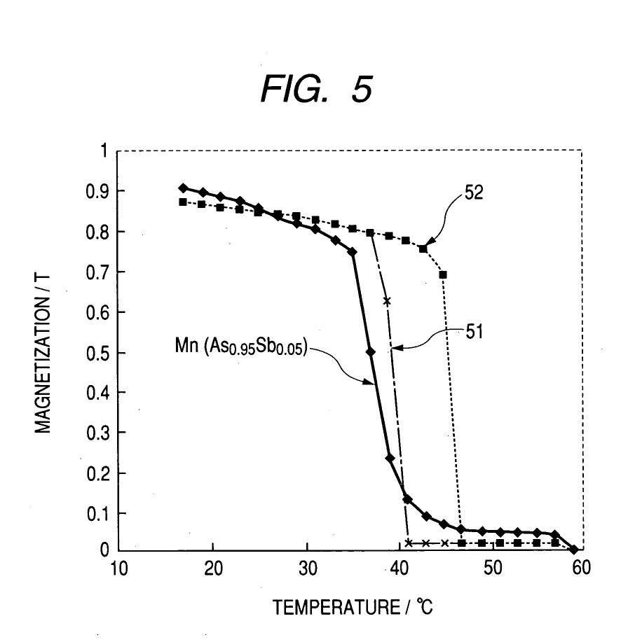

FIG. 5 illustrates the magnetization excursion of MnAs and Mn(As_{0.95}Sb_{0.05}) as a function of temperature. In FIG. 5, with MnAs, a hysteresis is observed in the phase transition between the normal and a stronger magnetizations, indicating the primary phase transition. Therefore, a large magnetization difference between the cooling and heating is obtainable by setting the cooling temperature at slightly lower than the lowest temperature on a cool-down hysteresis curve 51 while the heating temperature at slightly higher than the highest temperature on a warm-up hysteresis curve 52. For example, setting the cooling temperature to be a water temperature, at 35° C., and setting the heating temperature to be a heated wastewater from factories, at 50° C., will gain the magnetization difference of 0.8 tesla between the cooled the heated parts, which is approximately 8 times the magnetization difference with the cooling temperature at 30° C. and the heating temperature at 50° C. by using Ni₇₀Fe₃₀ alloy, a conventional temperature-sensitive magnetic material. Accordingly the mechanical energy output of approximately 8 times that with the conventional material can be obtained.

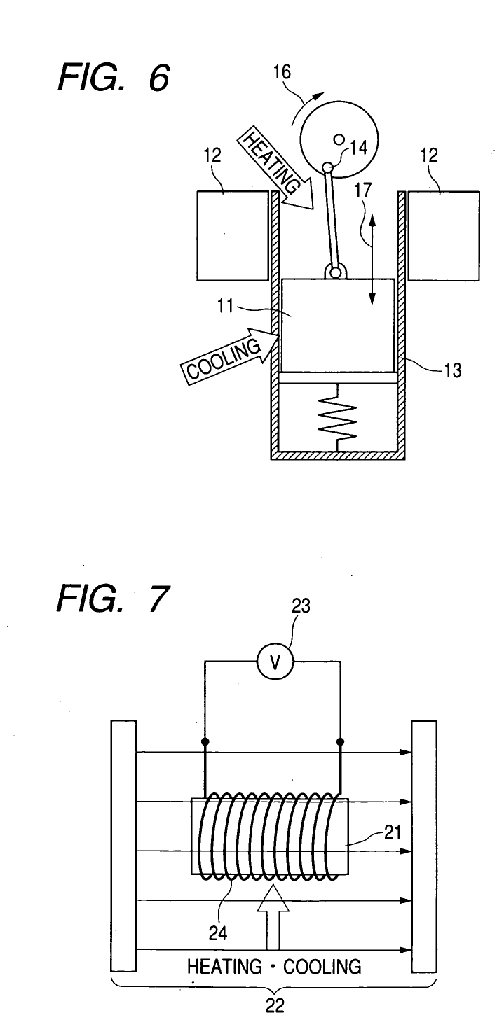

FIG. 6 illustrates a thermal engine of this embodiment. A piston 11 containing a temperature-sensitive magnetic material (hereinafter called piston 11) is mounted so as to reciprocate freely up and down in a piston cylinder 13. One face of the piston 11 is connected with the other end of a spring whose one end is connected with the bottom of the piston cylinder 13. On one hand, the other face of the piston 11 can be connected with a crank 14 as a support means thereof. On the other, the piston 11 is connected with a not-shown movable first supply pipe and a not-shown movable drainage pipe, and both the pipes reciprocate up and down in association with the piston 11 as indicated by the arrow 17. The first supply pipe is connected to a not-shown second supply pipe by way of a not-shown valve in order to supply from a not-shown coolant source, and to a not-shown third supply pipe to supply from a not-shown heat source. The valve switches between the second and third supply pipes through a not-shown actuator. And not-shown pumps control the heat source, the cooling source and the drainage pipes. A magnet 12 as a magnetic field generator is mounted so as to interleave the piston cylinder 13 and generates a magnetic field therein.

Referring to FIG. 6, the operation of the thermal engine will now be described.

When the magnetization of a temperature-sensitive magnetic material constituting the piston 11 is small, the piston 11 is at the bottom of the piston cylinder 13 by the restoring force of the spring. The piston 11 then is cooled down by the cooling water supplied through the second supply pipe by switching the valve with the actuator, resulting in the magnetization of the piston 11 increasing, hence piston 11 being attracted by the magnet 2 and thus being lifted upward. The cooling water in the piston 11 is then drained out through the drainage pipe, followed by switching the value to the third supply pipe with the actuator so as to connect with the heat source such as heated wastewater from factories and supplying to the now lifted piston 11. The magnetization of the piston 11 then decreases responding to the temperature rise, and the piston goes down again to the bottom of the piston cylinder by the restoring force of the spring. Then the heat source in the piston 11, the heated wastewater from the factories, is drained out through the drainage pipe. As such, in either side of the moving area of the piston 11, i.e., the lower part of the piston 11 (the cooling position) and the upper part thereof (the heating position), the magnetization difference of the temperature-sensitive magnetic material contained in the piston 11 is made possible. By cycling heating and cooling the piston 11 as described above, the piston 11 performs a reciprocal piston movement and thereby converting the thermal energy into the mechanical energy. In this instance, if the piston 11 is connected to the crank 14 so that the above described piston movement translates to the rotation of crank in the direction of arrow 16, then the mechanical energy is taken out as a rotational movement.

Although in this embodiment the heated wastewater from factories is used as the heat source, other heat sources such as exhaust heat from the equipment or the natural heat source such as the geothermal heat can also be used for this embodiment as long as it is capable of heating up the temperature-sensitive magnetic materials. While water is used for the coolant source, other cooling source such as air can be used in this embodiment as long as it is capable of cooling down the temperature-sensitive magnetic materials.

Although in this embodiment a spring is used as illustrated by FIG. 6, the gravitational force can be substituted as means to move the piston 11 toward the lower part of the piston cylinder 13.

Although in this embodiment the heating temperature is set at 50° C. and the cooling temperature at 35° C., the heating temperature can be discretional if it is higher than the highest temperature on the warm-up hysteresis curve and so is the cooling temperature if lower than the lowest temperature on the cool-down hysteresis curve.

In a thermal engine as illustrated in FIG. 6, conversions from the heat to the mechanical energy have been performed to compare the two temperature-sensitive magnetic materials, MnAs used in this embodiment and the conventionally used Ni₇₀Fe₃₀, under the same heating and cooling temperatures, resulting in a larger mechanical energy with the former material, MnAs.

In the thermal engine illustrated by FIG. 2 and shown in Related Background Art, when using MnAs, the temperature-sensitive magnetic material used in this embodiment, a larger magnetization difference is gained even with a small difference between the heating and cooling temperatures and thus a large mechanical energy is obtained.

As indicated by FIG. 5, use of Mn(As_{0.95}Sb_{0.05}), which is made by substituting 5% antimony (Sb) for arsenic (As) in MnAs, lowers the Curie temperature and hence the phase transition hysteresis. Substituting 10% or more of antimony further lowers the Curie temperature. The hysteresis disappears and hence becomes the secondary phase transition. With such material, there is no hysteresis and therefore it is beneficial in gaining a larger energy output with a smaller temperature difference. And by adjusting the composition, i.e., the amount of antimony substitution, the Curie temperature is adjustable so that an optimum material composition can be selected to suit the temperature of the heated wastewater from the factories as the heat source, or air or water temperature as the coolant source. Not only by antimony substitution but also by other substitution elements, the Curie temperature and the hysteresis curve can be changed, which makes it possible to select a suitable material in accordance with the operating condition.

In sum, according to this embodiment, use of MnAs and Mn(As_{0.95}Sb_{0.05}) as a temperature-sensitive magnetic material in the thermal engine using a magnetic body makes it possible to gain a large magnetization difference even with a small difference between the heating and cooling temperatures, hence obtaining a large mechanical energy. Further, a change in the amount of antimony substitution in Mn(As_{0.95}Sb_{0.05}) changes the Curie temperature.

(Embodiment 2)

This embodiment is a thermal engine according to the present invention using MnFe(P_{0.45}As_{0.55}) as a temperature-sensitive magnetic material.

MnFe(P₁₋ₓ,Asₓ), denotes that the composition ratio of phosphorous (P) to arsenic (As) is 1-x:x. In this embodiment, MnFe(P₁₋ₓAsₓ) can be used in a range of 0.2≦x≦0.8.

In this embodiment, with MnFe(P_{0.45}As_{0.55}), a steep magnetization variation is observed at the Curie temperature, approximately 25° C., at which point the phase transition from the normal to a strong magnetization occurs. This means MnFe(P_{0.45}As_{0.55}) is a material indicating the primary phase transition. Therefore, setting the heating and cooling temperatures straddling approximately 25° C. gains a large magnetization difference.

In this embodiment a thermal engine as illustrated in FIG. 6 is used. The construction and the operation have been described in Embodiment 1, and hence they are omitted here.

In the thermal engine illustrated in FIG. 6, MnFe(P_{0.45}As_{0.55}) is used as a temperature-sensitive magnetic material contained in the piston 11. For example, setting the cooling temperature at 17° C. and the heating temperature at 32° C. gains a magnetization difference of approximately 0.8 tesla between the cooled and heated parts. This indicates, the same as with MnAs in Embodiment 1, that a large mechanical energy is gained in a small temperature difference as compared with a conventional material, Ni₇₀Fe₃₀.

And in the thermal engine as illustrated by FIG. 2 and shown in Related Background Art, when using MnFe(P_{0.45}As_{0.55}), the temperature-sensitive magnetic material used in this embodiment, a large magnetization difference is gained even with a small difference between the heating and cooling temperatures and thus a large mechanical energy is obtained.

Further, with MnFe(P_{0.45}As_{0.55}) used for this embodiment, a variation in composition ratio of phosphorous (P) to arsenic (As) changes the Curie temperature. Specifically, a decrease in arsenic proportion lowers the Curie temperature, while an increase in arsenic proportion increases the Curie temperature. Addition of other substitution elements can also change the Curie temperature.

Therefore, the same as Mn(As,Sb) in Embodiment 1, adjusting the Curie temperature by the composition makes it possible to select an optimum material suitable to the operating environment such as the heat source temperature.

(Embodiment 3)

This embodiment is a thermal engine according to the present invention using La(Fe_{0.88}Si_{0.12})₁₃H₁₅ as a temperature-sensitive magnetic material.

Where denoted by La(Fe₁₋ₓSiₓ)₁₃H_{y}, the composition ratio of Fe to Si is 1-x:x. In this embodiment, La(Fe₁₋ₓSiₓ)₁₃H_{y} can be used in the range of 0.2≦x≦0.8, and 0≦y≦3.

In this embodiment, with La(Fe_{0.88}Si_{0.12})₁₃H_{1.5}, a steep magnetization variation is observed at the Curie temperature, approximately 60° C., at which point the phase transition from the normal to a stronger magnetization occurs. This means La(Fe_{0.88}Si_{0.12})₁₃H_{1.5} is a material indicating the primary phase transition. Therefore, setting the heating and cooling temperatures straddling approximately 60° C. gains a large magnetization difference.

In this embodiment a thermal engine as illustrated in FIG. 6 is used. The construction and operation have been described in Embodiment 1, and hence they are omitted here.

In the thermal engine illustrated in FIG. 6, La(Fe_{0.88}Si_{0.12})₁₃H_{1.5} is used as a temperature-sensitive magnetic material contained in the piston 11. For example, setting the cooling temperature at 52° C. and the heating temperature at 67° C. gains a magnetization difference of approximately 0.7 tesla between the cooled and heated parts. This indicates, the same as with MnAs in Embodiment 1, that a large mechanical energy output is gained in a small temperature difference as compared with a conventional material, Ni₇₀Fe₃₀.

And in the thermal engine as illustrated by FIG. 2 and shown in Related Background Art, when using La(Fe_{0.88}Si_{0.12})₁₃H_{1.5}, the temperature-sensitive magnetic material used in this embodiment, a large magnetization difference is gained even with a small difference between the heating and cooling temperatures and thus a large mechanical energy is obtained.

And with La(Fe_{0.88}Si_{0.12})₁₃H_{1.5} used in this embodiment, a variation in composition of hydrogen changes the Curie temperature. Specifically, a decrease in hydrogen proportion lowers the Curie temperature. Addition of other substitution elements can also change the Curie temperature.

Therefore, the same as Mn(As,Sb) in Embodiment 1, adjusting the Curie temperature by the composition makes it possible to select an optimum material suitable to the operating environment such as the heat source temperature.

(Embodiment 4)

This embodiment is a thermal engine according to the present invention using Gd(Si_{0.5}Ge_{0.5})₄ as a temperature-sensitive magnetic material.

Gd(Si₁₋ₓGeₓ)₄, denotes that the composition ratio of Si to Ge is 1-x:x. In this embodiment, Gd(Si₁₋ₓGeₓ)₄ can be used in the range of 0.4≦x≦0.6.

In this embodiment, with Gd(Si_{0.5}Ge_{0.5})₄, a steep magnetization variation is observed at the Curie temperature, approximately 3° C., at which point the phase transition from the normal to a strong magnetization occurs. This means Gd(Si_{0.5}Ge_{0.5})₄ is a material indicating the primary phase transition. Therefore, setting the heating and cooling temperatures straddling approximately 3° C. gains a large magnetization difference.

In this embodiment a thermal engine as illustrated in FIG. 6 is used. The construction and operation have been described in Embodiment 1, and hence they are omitted here.

In the thermal engine illustrated in FIG. 6, Gd(Si_{0.5}Ge_{0.5})₄ is used as a temperature-sensitive magnetic material contained in the piston 11. For example, setting the cooling temperature at 0° C. and the heating temperature at 15° C. gains a magnetization difference of approximately 0.6 tesla between the cooled and heated parts. This indicates, the same as with MnAs in Embodiment 1, that a large mechanical energy output is gained in a small temperature difference as compared with a conventional material, Ni₇₀Fe₃₀.

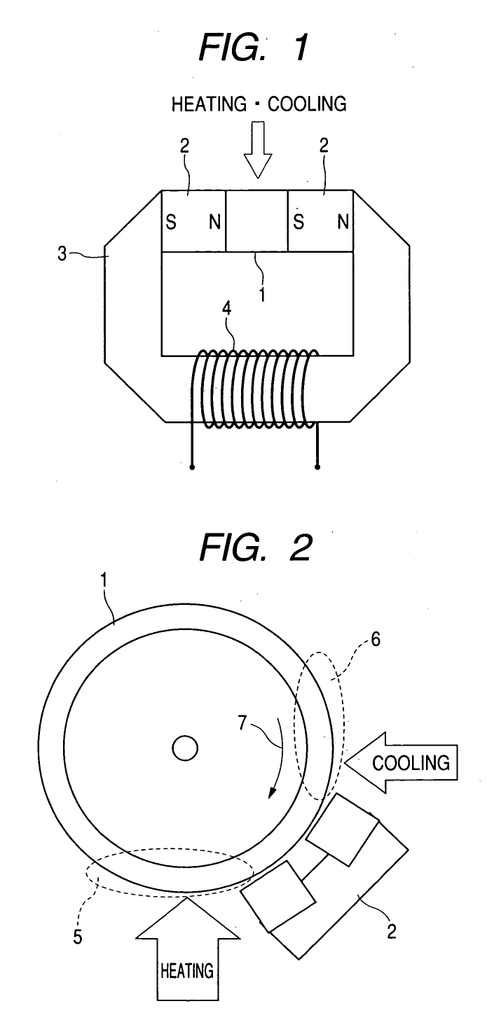

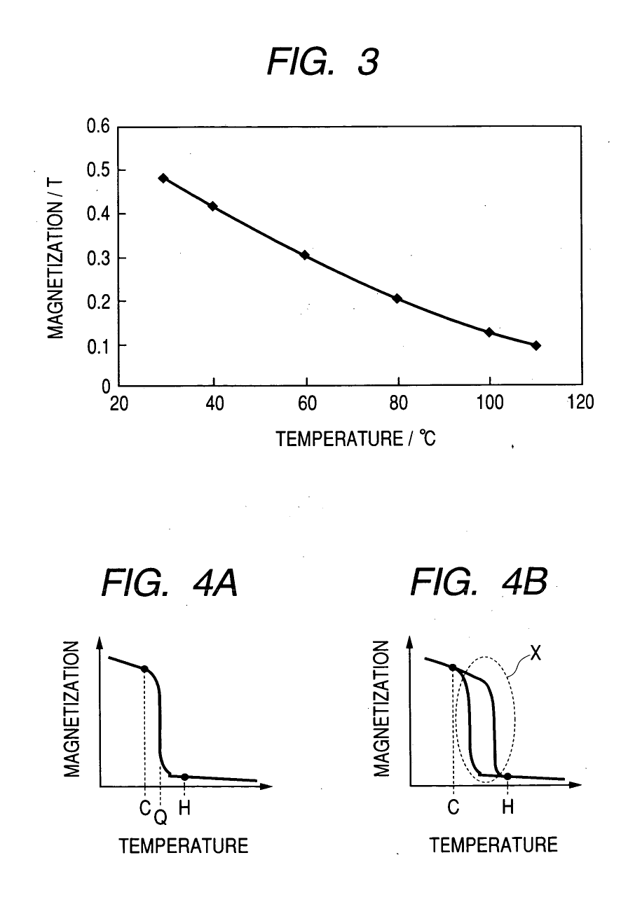

And in the thermal engine as illustrated by FIG. 1 and shown in Related Background Art, when using Gd(Si_{0.5}Ge_{0.5})₄, the temperature-sensitive magnetic material used in this embodiment, a large magnetization difference is gained even with a small difference between the heating and cooling temperatures and thus a large mechanical energy is obtained.

And with Gd(Si_{0.5}Ge_{0.5})₄ used for this embodiment, a variation in composition ratio of silicone (Si) to germanium (Ge) changes the Curie temperature. Addition of other substitution elements can also change the Curie temperature.

Therefore, the same as Mn(As,Sb) in Embodiment 1, adjusting the phase transition temperature by the composition makes it possible to select an optimum material suitable to the operating environment such as the heat source temperature.

(Embodiment 5)

This embodiment is a thermal power generator
according to the present invention using MnAs and Mn(As_{0.95}Sb_{0.05}) as the temperature-sensitive magnetic materials.

FIG. 7 illustrates a thermal power generator according to the present invention.

A container 21 containing grains made of a temperature-sensitive magnetic material (hereinafter called container 21) is wound into a coil 24, and is placed in the magnetic field of a magnetic field generator 22 in such a way that the circumferential direction of the coil 24 is perpendicular to the magnetic field. The temperature-sensitive magnetic material in the container is magnetized by the magnetic field generator 22. The coil 24 is connected to a voltmeter 23. The container 21 is also connected to a not-shown first supply pipe. The first supply pipe is connected, through a not-shown valve, with the not-shown second supply pipe supplying a heat source and a not-shown third supply pipe supplying the coolant source. The heat and cooling sources are supplied to the second supply pipe and the third supply pipe, respectively, by a not-shown pump. The valve is controlled by a not-shown actuator. The container 21 is also connected with a not-shown drainage pipe. The valve, the pump, the first supply pipe, the second supply pipe and the third supply pipe constitute the operating means. A not-shown battery can be connected in parallel with the voltmeter 23. The coil 24 can also be placed nearby the container 21. Further, the coil wound around the temperature-sensitive magnetic material and the coil placed nearby the container 21 can be serially connected.

The operation of a thermal power generator, illustrated by FIG. 7, using MnAs as a temperature-sensitive magnetic material, will now be described.

Switching the valve to the second supply pipe by the actuator supplies the heated wastewater from the factories as a heat source to the container 21, thus heating the container 21, which makes the magnetization of the temperature-sensitive magnetic material in the container 21 weaker and the magnetic flux through the coil 24 decrease. An electromotive force is produced in the coil 24 corresponding to the change in the magnetic flux. The heated wastewater from factories supplied to the container 21 is then discharged through the drainage pipe. Then, switching the valve to the third supply pipe by the actuator supplies water as a cooling source to the container 21, thus cooling the container 21, which makes the magnetization of the temperature-sensitive magnetic material in the container 21 stronger and the magnetic flux through the coil 24 increase. An electromotive force having the opposite sign to that of heating the container is now borne in the coil 24 corresponding to the change in the magnetic flux. The water supplied from factories to the container 21 is then discharged through the drainage pipe. The voltmeter 23 measures the voltage generated in the coil 24 as a result of cycling the heating and cooling repeatedly.

Although in this embodiment a heated wastewater from factories is used as the heat source, other heat source such as exhaust heat from the equipment or the natural heat source such as the geothermal heat can also be used for this embodiment as long as it is capable of heating up the temperature-sensitive magnetic materials. While water is used for the coolant source, other coolant sources such as air can be used in this embodiment as long as it is capable of cooling down the temperature-sensitive magnetic materials.

Although in this embodiment the heating temperature is set at 50° C. and the cooling temperature at 35° C., the heating temperature can be discretional if it is higher than the highest temperature on the warm-up hysteresis curve and so is the cooling temperature if lower than the lowest temperature on the cool-down hysteresis curve.

In the thermal power generator as illustrated in FIG. 7, conversions from the heat to the electric energy have been performed to compare the two temperature-sensitive magnetic materials, the conventionally used NdCo₅ and MnAs used in this embodiment, under the same heating and cooling temperatures, resulting in a larger electric energy with the material used in this embodiment, MnAs.

In sum, according to this embodiment, use of MnAs and Mn(As_{0.95}Sb_{0.05}) as a temperature-sensitive magnetic material in the thermal power generator using a magnetic body makes it possible to gain a large magnetization difference even with a small difference between the heating and cooling temperatures, hence obtaining a large electric energy. The cooling temperature can be set at the ambient temperature. Further, a change in the amount of antimony substitution in Mn(As_{0.95}Sb_{0.05}) changes the Curie temperature.

(Embodiment 6)

This embodiment is a thermal power generator according to the present invention using MnFe(P_{0.45}As_{0.55}) as a temperature-sensitive magnetic material.

Where denoted by MnFe(P₁₋ₓAsₓ), the composition ratio of P and As is 1-x:x. In this embodiment, MnFe(P₁₋ₓAsₓ) can be used in the range of 0.2≦x≦0.8.

In this embodiment, with MnFe(P_{0.45}As_{0.55}), a steep magnetization variation is observed at the Curie temperature, approximately 25° C., at which point the phase transition from the normal to the strong magnetization occurs. This means MnFe(P_{0.45}As_{0.55}) is a material indicating the primary phase transition. Therefore, setting the heating and cooling temperatures straddling approximately 25° C. gains a large magnetization difference. Further, the cooling temperature can be set at the ambient temperature because of its Curie temperature being approximately 25° C.

In this embodiment a thermal power generator as illustrated in FIG. 7 is used. The construction and the operation have been described in Embodiment 5, and hence they are omitted here.

In the thermal power generator illustrated in FIG. 7, MnFe(P_{0.45}As_{0.55}) is used as a temperature-sensitive magnetic material contained in the container 21. For example, setting the cooling temperature at 7° C. and the heating temperature at 32° C. gains a magnetization difference of approximately 0.8 tesla between the cooled and heated parts. This indicates, the same as with MnAs in Embodiment 1, that a large electric energy output is gained in a small temperature difference as compared with a conventional material, NdCO₅.

And with MnFe(P_{0.45}As_{0.55}) used for this embodiment, a variation in composition ratio of phosphorous (P) to arsenic (As) changes the Curie temperature. Specifically, a decrease in arsenic proportion lowers the Curie temperature, while an increase in the arsenic proportion raises the Curie temperature. Addition of other substitution elements can also change the Curie temperature.

Therefore, the same as Mn(As,Sb) in Embodiment 5, adjusting the Curie temperature by the composition makes it possible to select an optimum material suitable to the operating environment such as the heat source temperature.

(Preferred Embodiment 7)

This embodiment is a thermal power generator according to the present invention using La(Fe_{0.88}Si_{0.12})₁₃H_{1.5} as a temperature-sensitive magnetic material.

Where denoted by La(Fe₁₋ₓSiₓ)₁₃Hy, the composition ratio of Fe to Si is 1-x:x. In this embodiment, La(Fe₁₋ₓSiₓ)₁₃HY can be used in the range of 0.2≦x≦0.8, and 0≦y≦3.

In this embodiment, with La(Fe_{0.88}Si_{0.12})₁₃H_{1.5}, a steep magnetization variation is observed at the Curie temperature, approximately 60° C., at which point the phase transition from the normal to a strong magnetization occurs. This means La(Fe_{0.88}Si_{0.12})₁₃H_{1.5} is a material indicating the primary phase transition. Therefore, setting the heating and cooling temperatures straddling approximately 60° C. gains a large magnetization difference. Further, the cooling temperature can be set at the ambient temperature because of its Curie temperature being 60° C.

In this embodiment a thermal power generator as illustrated in FIG. 7 is used. The construction and the operation have been described in Embodiment 5, and hence they are omitted here.

In the thermal power generator illustrated in FIG. 7, La(Fe_{0.88}Si_{0.12})₁₃H_{1.5} is used as a temperature-sensitive magnetic material contained in the container 21. For example, setting the cooling temperature at 52° C. and the heating temperature at 67° C. gains a magnetization difference of approximately 0.7 tesla between the cooled and heated parts. This indicates, the same as with MnAs in Embodiment 1, that a large electric energy output is gained in a small temperature difference as compared with a conventional material, NdCO₅.

And with La(Fe_{0.88}Si_{0.12})₁₃H_{1.5} used in this embodiment, a variation in composition of hydrogen changes the Curie temperature. Specifically, a decrease in hydrogen proportion lowers the Curie temperature. Addition of other substitution elements can also change the Curie temperature.

Therefore, the same as Mn(As,Sb) in Embodiment 1, adjusting the Curie temperature by the composition makes it possible to select an optimum material suitable to the operating environment such as the heat source temperature.

(Preferred Embodiment 8)

This embodiment is a thermal power generator according to the present invention using Gd(Si_{0.5}Ge_{0.5})₄ as a temperature-sensitive magnetic material.

Where denoted by Gd(Si₁₋ₓGeₓ)₄, the composition ratio of Si to Ge is 1-x:x. In this embodiment, Gd(Si₁₋ₓGeₓ)₄ can be used in the range of 0.4≦x≦0.6.

In this embodiment, with Gd(Si_{0.5}Ge_{0.5})₄, a steep magnetization variation is observed at the Curie temperature, approximately 3° C., at which point the phase transition from the normal to the strong magnetization occurs. This means Gd(Si_{0.5}Ge_{0.5})₄ is a material indicating the primary phase transition. Therefore, setting the heating and cooling temperatures straddling approximately 3° C. gains a large magnetization difference. Further, the cooling temperature can be set at a higher temperature as compared with a conventional material, NdCO₅ because of its Curie temperature being approximately 3° C.

In this embodiment a thermal power generator as illustrated in FIG. 7 is used. The construction and operation have been described in Embodiment 5, and hence they are omitted here.

In the thermal power generator illustrated in FIG. 7, Gd(Si_{0.5}Geo_{0.5})₄ is used as a temperature-sensitive magnetic material contained in the container 21. For example, setting the cooling temperature at 0° C. and the heating temperature at 15° C. gains a magnetization difference of approximately 0.6 tesla between the cooled and heated parts. This indicates, the same as with MnAs in Embodiment 1, that a large electric energy output is gained in a small temperature difference as compared with a conventional material, NdCO₅.

And with Gd(Si_{0.5}Ge_{0.5})₄ used for this embodiment, a variation in composition ratio of silicone (Si) to germanium (Ge) changes the Curie temperature. Addition of other substitution elements can also change the Curie temperature.

Therefore, as with Mn(As,Sb) in Embodiment 1, adjusting the phase transition temperature by the composition makes it possible to select an optimum material suitable to the operating environment such as the heat source temperature.

This application claims priority from Japanese Patent Application Nos. 2003-316087 filed Sep. 8, 2003 and 2003-316088 filed Sep. 8, 2003, which are hereby incorporated by reference herein.

1. A thermal engine using a magnetic body having a magnetization variable with temperature as a result of the phase transition from the paramagnetic to ferromagnetic phase, and converting heat into a mechanical energy by cycling heating and cooling the magnetic body, comprising:
a heat source to heat up the magnetic body;
a cooling source to cool down the magnetic body;
support means for supporting the magnetic body movably;
magnetic field generation means for generating a field in a part of the moving area; and
means for causing the magnetization variation in the magnetic body in a part of the moving area where a field is generated by the magnetic field generation means and in either side of the moving area by subjecting the magnetic body to the heating by the heat source and cooling by the coolant source,
wherein the heating and the cooling temperatures straddle a temperature at which the magnetic body indicates the maximum magnetization variation with temperature as a result of the first order phase transition thereof.

2. The thermal engine according to claim 1, wherein magnetic materials for magnetic bodies whose magnetization varies with temperature are compounds selected from the group consisting of MnAs; Mn(As₁₋ₓSbₓ): 0<x≦0.2); MnFe(P₁₋ₓAsₓ) (0.2≦x≦0.8); La(Fe₁₋ₓSiₓ)₁₃H_{y} (0<x≦0.2, 0<y≦3) and Gd₅(Si₁₋ₓGeₓ)₄ (0.4. ≦x≦0.6).

3. The thermal engine according to claim 2, wherein the cooling source is either atmospheric air or water.

4. The thermal engine according to claim 1, wherein the heat source is either heated wastewater from factories, exhaust heat from equipment or the natural heat source such as geothermal heat.

5. The thermal engine according to claim 4, wherein the cooling source is either atmospheric air or water.

6. The thermal engine according to claim 1, wherein the cooling source is either atmospheric air or water.

7. A thermal engine using a magnetic body having a magnetization variable with temperature as a result of the phase transition from the paramagnetic to ferromagnetic phase, and converting heat into a mechanical energy by cycling heating and cooling the magnetic body, comprising:
a heat source to heat up the magnetic body;
a cooling source to cool down the magnetic body;
support means for supporting the magnetic body movably;
magnetic field generation means for generating a field in a part of the moving area; and
means for causing the magnetization variation in the magnetic body in a part of the moving area where a field is generated by the magnetic field generation means and in either side of the moving area by subjecting the magnetic body to the heating by the heat source and cooling by the coolant source,
wherein the heating and the cooling temperatures straddle a temperature at which the magnetic body undergoes the second order phase transition indicating the maximum magnetization variation with temperature as steep as in the first order phase transition thereof.

8. The thermal engine according to claim 7, wherein the cooling source is either atmospheric air or water.

9. A thermal engine using a magnetic body having a magnetization variable with temperature as a result of the phase transition from the paramagnetic to ferromagnetic phase, and converting heat into a mechanical energy by cycling heating and cooling the magnetic body, comprising:
a heat source to heat up the magnetic body;
a cooling source to cool down the magnetic body;
support means for supporting the magnetic body movably;
magnetic field generation means for generating a field in a part of the moving area; and
means for causing the magnetization variation in the magnetic body in a part of the moving area where a field is generated by the magnetic field generation means and in either side of the moving area by subjecting the magnetic body to the heating by the heat source and cooling by the coolant source,
wherein the magnetic body indicates a magnetization variation of 0.5 tesla or greater for the difference between the heating and cooling temperatures being 10° C. or less.

10. A thermal power generator using a magnetic body having a magnetization variable with temperature as a result of the phase transition from the paramagnetic to ferromagnetic phase, and converting heat into an electric energy by cycling heating and cooling the magnetic body, comprising:
a heat source to heat up the magnetic body;
a cooling source to cool down the magnetic body; and
operating means for subjecting the magnetic body alternately to the heating by the heat source and cooling by the coolant source,
wherein the heating and the cooling temperatures straddle a temperature at which the magnetic body indicates the maximum magnetization variation with temperature as a result of the first order phase transition thereof.

11. The thermal power generator according to claim 9, wherein the magnetic materials are compounds selected from the group consisting of MnAs;
Mn(As₁₋ₓSbₓ): 0<x≦0.2); MnFe(P₁₋ₓAsₓ) (0.2≦x≦0.8); La(Fe₁₋ₓSiₓ)₁₃H_{y} (0≦x≦0.2, 0≦y≦3) and Gd₅(Si₁₋ₓGeₓ)₄ (0.4. ≦x≦0.6).

12. The thermal power generator according to claim 9, wherein a magnetic field generation device is additionally installed to apply a bias field to the magnetic body.

13. The thermal power generator according to claim 9, wherein the heat source is either heated wastewater from factories, exhaust heat from equipment or a natural heat source such as geothermal heat.

14. The thermal power generator according to claim 9, wherein the cooling source is either atmospheric air or water.

15. A thermal power generator using a magnetic body having a magnetization variable with temperature as a result of the phase transition from the paramagnetic to ferromagnetic phase, and converting heat into an electric energy by cycling heating and cooling the magnetic body, comprising:
a heat source to heat up the magnetic body;
a cooling source to cool down the magnetic body; and
operating means for subjecting the magnetic body alternately to the heating by the heat source and cooling by the coolant source,
wherein the heating and the cooling temperatures straddle a temperature at which the magnetic body undergoes the second order phase transition indicating the maximum magnetization variation with temperature as steep as in the first order phase transition thereof.

16. A thermal power generator using a magnetic body having a magnetization variable with temperature as a result of the phase transition from the paramagnetic to ferromagnetic phase, and converting heat into an electric energy by cycling heating and cooling the magnetic body which is magnetized beforehand, comprising:
a heat source to heat up the magnetic body;
a cooling source to cool down the magnetic body; and
operating means for subjecting the magnetic body alternately to the heating by the heat source and cooling by the coolant source,
wherein the magnetic body indicates a magnetization difference of 0.5 tesla or greater for the difference between the heating and the cooling temperatures being 10° C. or less.
